(19) United States
(12) Patent Application Publication
(10) Pub. No.: US 2009/0088124 A1
(43) Pub. Date: Apr. 2, 2009

(54) Radio Frequency Receiver Architecture

(75) Inventors: Axel Schuur, Mountain View, CA (US); Ann P. Shen, Saratoga, CA (US)

Correspondence Address: FISH & RICHARDSON P.C., P.O. BOX 1022, MINNEAPOLIS, MN, 55440-1022, US

(73) Assignee: NanoAmp Solutions, Inc. (Cayman), Santa Clara, CA (US)

(21) Appl. No.: 12/237,038

(22) Filed: Sep. 24, 2008

Related U.S. Application Data
(60) Provisional application No. 60/975,702, filed on Sep. 27, 2007.

(51) Int. Cl. H04B 1/16

(52) U.S. Cl. 455/341

(57) ABSTRACT

A receiver includes a common-gate low noise amplifier (LNA) configured to receive an RF input signal and produce an amplified RF signal. A down-converting passive mixer is configured to mix the amplified received RF input signal with a local oscillator signal generated by a local oscillator to generate a down-converted amplified signal. An amplifier is configured to amplify the down-converted signal and has an input impedances in on the order of ohms. Only a single LNA may be required to receive RF inputs in all frequency bands of a multi-band communication standard.

### CROSS-REFERENCE TO RELATED APPLICATIONS

This application claims the benefit of priority from U.S. Provisional Application entitled “Radio Frequency Receiver Architecture,” Application No. 60/975,702 filed Sep. 27, 2007, the disclosure of which is incorporated by reference.

### TECHNICAL FIELD

This disclosure relates to signal processing in radio frequency (RF) receivers.

### BACKGROUND

Architectures for integrated receivers may include RF band select filters to attenuate out-of-band blockers. In particular, communications standards, such as the Global System for Mobile Communication (GSM) may have requirements which encourage the use of such band select filters to attenuate out-of band blockers. In particular, such blockers can be as strong as 0 dBm as defined by the GSM standard.

### SUMMARY

In general, implementations feature a circuit for a multi-band Global System for Mobile Communication (GSM) radio frequency (RF) front end. The circuit for the multi-band Global System for Mobile Communication (GSM) radio frequency (RF) front end includes a single common-gate low noise amplifier (LNA) configured to receive an RF input signal and produce an amplified RF signal, a down-converting passive mixer configured to configured to mix the amplified RF signal with a local oscillator signal generated by a local oscillator to generate a down-converted signal, and an amplifier configured to amplify the down-converted signal. The amplifier has an input impedance on the order of ohms.

These and other embodiments can optionally include one or more of the following features. The down-converting passive mixer can be configured to down-convert the amplified RF signal to an intermediate frequency (IF), a low IF or a zero frequency signal. The down-converting passive mixer can be coupled to an output of the single LNA via one or more capacitors to block direct current in the amplified RF signal. The one or more capacitors can be coupled between an output of the down-converting passive mixer and a ground for blocking leaked RF signals produced by the local oscillator. The received RF input signal can be differential. The common-gate LNA, the local oscillator signal, the down-converting passive mixer and the amplifier can be differential. The received RF signal can be single-ended. The common-gate LNA can be configured to convert the amplified received signal to a differential signal. The local oscillator signal, the down-converting passive mixer and the amplifier can be differential. The down-converting passive mixer can include transmission gates formed from one or more transistors. A 3^{rd} order input referred interception point (IIP3) of the LNA can be approximately greater than 10 dBm. The amplifier can be a transimpedance amplifier with feedback impedances to amplify and to convert the down-converted signal to a voltage mode. The transimpedance amplifier can include an operational amplifier. The operational amplifier can include one or more bipolar transistors as input devices. The bipolar transistors can reduce a noise figure by approximately 5 dB. The one or more bipolar transistors can be parasitic transistors formed by a complementary metal-oxide-semiconductor (CMOS) or metal-oxide-semiconductor-semiconductor (CMOS) or metal-oxide-semiconductor-field-effect-transistor (MOSFET) fabrication process technology. The RF front end can be implemented using a MOSFET, a bipolar-complementary-CMOS (BiCMOS) or a Silicon-Germanium (SiGe) fabrication process technology. The LNA and the mixer can be configured such that a bandwidth of the LNA and the mixer can cover a full range of frequencies for all bands of a multi-band communication standard or multiple communication standards.

In general, some implementations feature a circuit for a multi-band Global System for Mobile Communication (GSM) radio frequency (RF) receiver. The circuit for a multi-band Global System for Mobile Communication (GSM) radio frequency (RF) receiver includes an antenna configured to receive a radio frequency (RF) input signal, and a switch configured to switch between a transmit mode and a receive mode. For the receive mode, the switch is configured to pass the received RF input signal through an RF front end that includes a first amplifier configured as a common-gate low noise amplifier, a first mixer configured as a down-converting passive mixer to mix an output signal of the first amplifier with a first local oscillator signal to down-convert the output signal of the first amplifier and a second amplifier configured as a transimpedance amplifier using one or more bipolar transistors as input devices. The circuit includes a second mixer configured to mix an output of the second amplifier with a second local oscillator signal to down-convert the output of the second amplifier, and a third amplifier configured to amplify an output of the second mixer.

These and other embodiments can optionally include one or more of the following features. The circuit can include an analog to digital converter (ADC) coupled to an output of the third amplifier and configured to convert an output of the third amplifier to a digital output signal before proceeding to a digital signal processor or to a baseband circuit for circuit for further processing. The circuit can include a transmitter, in which the receiver and the transmitter can be formed on a monolithic transceiver integrated circuit. The multi-band GSM receiver can be formed using a MOSFET, a bipolar-CMOS (BiCMOS) or a Silicon-Germanium (SiGe) fabrication process technology.

In general, some implementations feature a method of operating a multi-band Global System for Mobile Communication (GSM) radio frequency (RF) front end. The method of operating a multi-band Global System for Mobile Communication (GSM) radio frequency (RF) front end involves amplifying an RF input signal with a single common-gate low noise amplifier (LNA) to generate an amplified RF signal, receiving the amplified RF signal with a down-converting passive mixer and mixing the amplified RF signal with a local oscillator signal generated by a local oscillator to generate a down-converted signal, and amplifying the down-converted signal with an amplifier. The amplifier has an input impedance on the order of ohms.

These and other embodiments can optionally include one or more of the following features. The mixing of the amplified received RF input signal with a local oscillator signal can include down-converting the amplified RF signal to an IF, a low IF, or a zero frequency signal. The reception of the amplified RF signal with a down-converting passive mixer can include receiving the amplified RF signal via one or more capacitors that block direct current in the amplified RF signal. The method can include blocking leaked RF signals the local oscillator using one or more capacitors coupled between an output of the down-converting passive mixer and a ground. The RF input signal can be differential. The common-gate LNA, the local oscillator signal, the down-converting passive mixer and/or the amplifier can be differential. The RF input signal can be single-ended. The method can include converting the RF input signal to a differential signal using the common-gate LNA. The local oscillator using the common-gate LNA. The local oscillator signal, the down-converting passive mixer and/or the amplifier can be differential. The down-converting passive mixer can include transmission gates formed from one or more transistors. A 3^{rd} order input referred interception point (IIP3) of the LNA can be approximately greater than 10 dBm. The amplifier can be a transimpedance amplifier with feedback impedances to amplify and to convert the down-converted signal to a voltage mode. The transimpedance amplifier can include an operational amplifier. The operational amplifier can include one or more bipolar transistors as input devices. The bipolar transistors can reduce a noise figure by approximately 5 dB. The one or more bipolar transistors can be parasitic transistors formed by a complementary metal-oxide-semiconductor (CMOS) or metal-oxide-semiconductor-field-effect-transistor (MOSFET) fabrication process technology. The RF front end can be implemented using a MOSFET, a bipolar-CMOS (BiCMOS), or a Silicon-Germanium (SiGe) fabrication process technology. The LNA and the mixer can be configured such that a bandwidth of the LNA and the mixer covers a full range of frequencies for all bands of a multi-band communication standard or multiple communication standards.

In general, some implementations feature a multi-band Global System for Mobile Communication (GSM) receiver. The multi-band Global System for Mobile Communication (GSM) receiver includes an antenna configured to receive a radio frequency (RF) input signal, and a first amplifier configured as a single common-gate low noise amplifier, in which the first amplifier is coupled to an output of the antenna. The receiver includes first down-converting I and Q mixers configured as a passive mixer, in which the first I and Q down-converting mixers are coupled to an output of the first amplifier and first I and Q local oscillator signals, respectively. The receiver includes first I and Q amplifiers configured to first I and Q amplifiers configured to have an input impedance on the order of ohms, in which the first I and Q amplifiers are coupled to outputs of the first I and Q down-converting mixers, respectively. The receiver includes second I and Q mixers coupled to outputs of the I and Q amplifiers and second I and Q local oscillator signals, respectively, and I and Q low pass filters coupled to I and Q outputs of the second I and Q mixers, respectively.

These and other embodiments can optionally include one or more of the following features. The first I and Q amplifiers can be transimpedance amplifiers. The LNA can have a single-ended input and differential outputs, and the first and the second I and Q mixers, and the first and second I and Q amplifiers can be differential.

Details of one or more implementations are set forth in the accompanying drawings and description herein. Other features, aspects, and advantages will be apparent from the description, the drawings, and the claims.

### DESCRIPTION OF THE DRAWINGS

FIG. 1 is a schematic of an example of a receiver/transmitter circuit with band select filters in the receive path.

FIG. 2 is a schematic of an example of a receiver/transmitter circuit without band select filters in the receive path.

FIG. 3 is a schematic of an example of a receiver circuit with a common-gate low-noise amplifier and a passive down-converting mixer.

FIG. 4 is a schematic of an example of a receiver circuit with a common-gate low-noise amplifier and a passive down-converting mixer configured as part of an image-rejecting receiver.

FIG. 5 is a schematic of an example of an operational amplifier as part of a transimpedance amplifier in the mixer subsystem.

FIG. 6 is a schematic of an example of a low intermediate frequency (IF) receiver.

FIG. 7 is a schematic of an example of a direct-conversion receiver.

### DETAILED DESCRIPTION

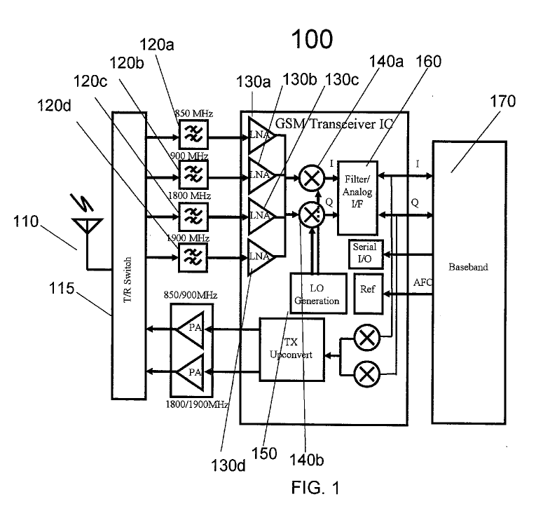

FIG. 1 is a schematic of an example of a receiver/transmitter circuit 100 with band select filters 120a-120d. The receiver/transmitter circuit 100 is, for example, a multi-band GSM receiver.

The circuit 100 includes a signal input/output 110 (e.g., an antenna) coupled to a transmit/receive switch 115, which selectively connects the transmit or receive paths to the signal input/output 110. In the receive path, a signal received by antenna 110 is sent to multiple band select filters 120a-120d. Each band select filter passes a particular frequency band, while attenuating signals outside of the particular frequency band. The band select filters 120a-120d may be implemented using external filters, such as, Surface Acoustic Wave (SAW) filters.

Each of the band select filters 120a-120d is coupled to a corresponding low noise amplifier (LNA) 130a-130d, which amplifies the received signal. The outputs of the LNAs 130a-130d are coupled to an in-phase down-converting mixer 140a and a quadrature down-converting mixer 140b, which are respectively driven by a first signal and a second signal from a local oscillator 150, with the first signal being 90 degrees out-of-phase with respect to the second signal. The in-phase signal from the in-phase down-converting mixer 140a and the quadrature signal from the quadrature down-converting mixer 140b are further filtered mixer 140b are further filtered and down-converted to the baseband frequency, i.e. zero frequency by processing block 160, for example, for a low IF receiver architecture, and the baseband in-phase and quadrature signals are coupled to the baseband processing block 170 for baseband processing. For a direct conversion or zero IF receiver architecture, the in-phase and quadrature mixers 140a and 140b down-convert the differential output signals of the LNAs 130a-130d directly to the baseband frequency, thus obviating the second mixer in the processing block 160 for a low IF receiver.

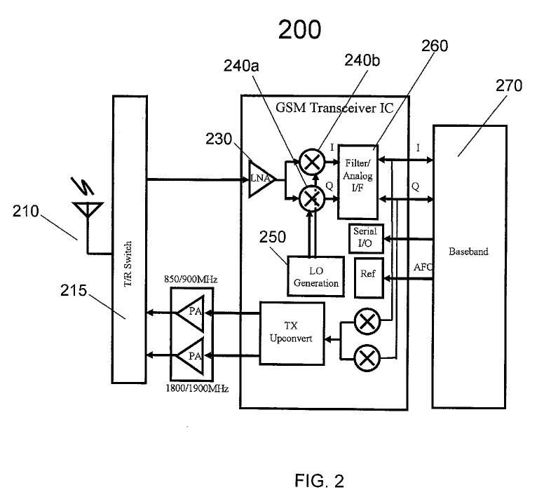

FIG. 2 is a schematic of an example of a multi-band receiver/transmitter circuit 200 without band select filters. In particular, the circuit 200 is an example of a multi-band GSM receiver using only a single LNA 230 and no external RF band select filters, and is similar to circuit 100 except for the single LNA 230 and lack of band select filters. To accommodate the lack of band filters and the use of a single LNA, however, the circuit 200 is designed with certain performance parameters.

I particular, the circuit 200 is designed with certain performance parameters for the 3rd-order nonlinearity of the LNA 230 and the down-converting mixer subsystem 240a and 204b, the bandwidth of the LNA 230 and mixers 240a and 240b, and the phase noise of the local oscillator circuit 250. With respect to the 3rd-order non-linearity, the LNA 230 and mixer subsystem 240a and 240b are designed so as to not exhibit significant gain compression if the power of an input signal 210 is 0 dBm for an out-of band blocking signal (out-of-band blocking signals may not be attenuated due to the lack of band select filters). To that end, the LNA 230 and the mixers 240a and 240b input referred 1-dB compression point is designed to be at least 0 dBm for some implementations. Under the assumption of implementations. Under the assumption of 3rd-order nonlinearity dominating the compression effects, the corresponding input referred interception point IIP3 at the LNA 230 may require to be about greater than +10 dBm

Also, the single LNA 230 and the mixers 240a and 240b may be designed with a bandwidth to accommodate all of the expected bands for a given design. For example, under the GSM standard, to cover all four possible bands, the single LNA 230 and mixer subsystem 240a and 240b are designed to have a bandwidth that covers the frequency range from 869 MHz to 1990 MHz.

Further, the local oscillator circuit 250 driving the down-converting mixers 240a and 240b may be designed with particular phase noise parameters. When a band select filter 120 is used, the most limiting requirement can arise from an in-band blocking signal at 3 MHz offset from the wanted channel at a power level up to approximately −20 dBm. Therefore, the LO phase noise may need to be less than −135 dBc/Hz at 3 MHz offset to not increase the effective noise figure from mixing. Without the band select filters 120, additional blocking signals may appear stronger. In particular, blocking signals −5 dBm at offsets as small as 10 MHz, and 0 dBm at offsets as small as 20 MHz may appear. Such blocking signals may lead to phase noise requirements of −153 dBc/Hz at 10 MHz offset and −158 dBc/Hz at 20 MHz offset.

Because the circuit 200 does not use band select filters, the size and cost of circuit 200 may be able to be reduced when compared to circuit 100, which uses external band select filters, such as SAW filters. Also, since band select filters are not used, a single LNA may be employed, instead of a separate LNA for each band, as in the circuit 100. The use of a single LNA for multiple bands further reduces chip area and power consumption.

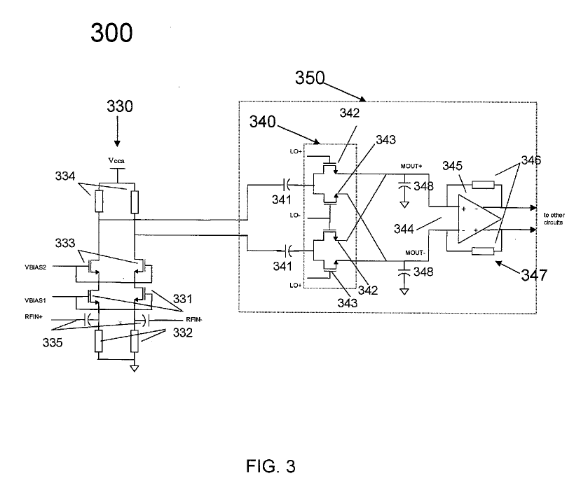

FIG. 3 is a schematic of an example of a circuit 300 that may be used to implement an LNA 330 and a mixer subsystem 350. Mixer subsystem 350 includes a differential mixer 340 formed from two mixers and an amplifier 347. In particular for one implementation, circuit 300 includes a differential LNA 330 implemented as a common-gate amplifier, a differential down-converting mixer 340 implemented using passive mixers based on transmission gates to act as switches and an amplifier 347 implemented as a transimpedance amplifier based on an operational amplifier with feedback impedances. The circuit 300 may exhibit sufficient linearity to obviate RF filters in, for example, the circuit 100 of FIG. 1 and to support an IIP3 of the single LNA 330 to be greater than +10 dBm.

Generally, common-gate LNAs, such as LNA 330, can exhibit wider bandwidth and higher linearity than common-source LNAs. In this implementation, the differential common-gate LNA 330 includes input NMOS transistors 331 that may provide a defined input impedance over a wide bandwidth. A pair of source impedances 332 may act as an RF choke to provide bias. A second bias may be applied to the gate terminals of the input transistors 331.

A differential RF signal RFIN enters the differential LNA 330 at source terminals of the input transistors 331 via capacitors 335 which are used to filter certain direct current (DC) components from the differential RF input signal RFIN which can be converted from a single-ended RF input signal by a balun before the LNA 330. In some implementations, the LNA 330 can be designed to convert a single-ended RF input signal to a differential output signal. After passing through the input device 331, the differential RF input signal RFIN enters into the output devices 333 of the differential LNA 330. The pair of the LNA output load impedances 334 may be chosen with a high value, for example, on the order of kilo-example, on the order of kilo-Ohms. Each passive mixer of the passive differential mixer 340 includes a pair of transmission gates. For example, each of the passive mixers includes one transmission gate formed from transistor 342 and a second transmission gate formed from transistor 343. The differential output from the differential LNA 330 is applied to the differential input of the differential passive mixer 340, i.e. drain terminals of the transmission gate transistors 342 and 343, to mix with the differential local oscillator signal LO applied to the gate terminals of the transmission gate transistors 342 and 343. The differential output of the differential passive mixer 340 is terminated with a pair of low load impedances for example, in the order of ohms. The pair of load impedances of the mixer 340 can have an equal value or different values. The bandwidth of the LNA 330 and the mixer 340 can have a range that covers the full range of frequencies for all bands of a multi-band communication standard or multiple communication standards. For example, in a quad-band GSM system, the bandwidth for the LNA 330 and the mixer 340 can have a frequency range from 869 MHz to 1990 MHz.

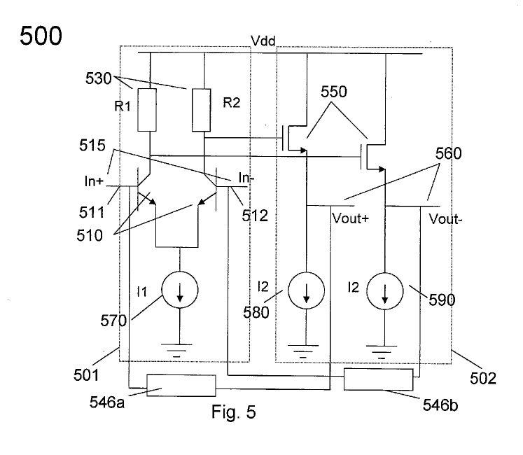

In one implementation, a low impedance in the order of ohms may be provided by a transimpedance amplifier 347 including an operational amplifier 345 and feedback impedances 346. The amplifier 347 may provide low impedance (“virtual ground”) at its input terminals 344. In such a configuration, the transmission gate transistors 342 and 343, together with the low impedance termination, provide a low impedance path at the differential output of the LNA 330 such that substantially all signal current may flow from the differential output of the LNA 330 via the DC blocking capacitors 341 through the differential passive mixer 340, i.e. transmission gate transistors 342 and 343, to the differential input 344 of the transimpedance amplifier 347. At the transimpedance amplifier 347, the down-converted differential output signal MOUT of the differential mixer 340 may mixer 340 may be amplified with a positive gain and converted to a voltage mode by the feedback impedances 346. The feedback impedances 346 may also provide a filtering function such as to attenuate blocking signals. In some implementations, the transimpedance amplifier can be implemented with bipolar transistors as input devices to reduce mixer noise figure by an order of 5 dB. An example implementation of the transimpedance amplifier is shown in FIG. 5.

Shunt capacitors 348 may be provided at the differential output 344 of the passive mixer 340, i.e. drain terminals of the transmission gate transistors 342 and 343, to attenuate RF signals, e.g. leakage of the local oscillator (LO) signal driving the transmission gate transistors 342 and 343.

In a configuration as described, the voltage swing at the input and output terminals of the transmission gates, which are formed by the sources and drains of the transmission gate transistors, may be very small. As a result, in such a configuration the mixer 340 may exhibit linearity performance which may be better suited to RF frequency communication than other mixer topologies, such as active mixers or “Gilbert cells.” LNA 330 may have a higher noise figure than a common-source LNA. In various implementations, the higher noise figure can be tolerated since the band select filters 120 that would otherwise cause 1-2 dB insertion loss are eliminated. For example, to achieve the same sensitivity performance using circuit 300 instead of the band select filters 120a-120d and LNAs 130a-130d of receiver circuit 100, the noise figure of the LNA 330 can be higher in proportion to the amount of insertion loss that would occur as a result of a band-select filter.

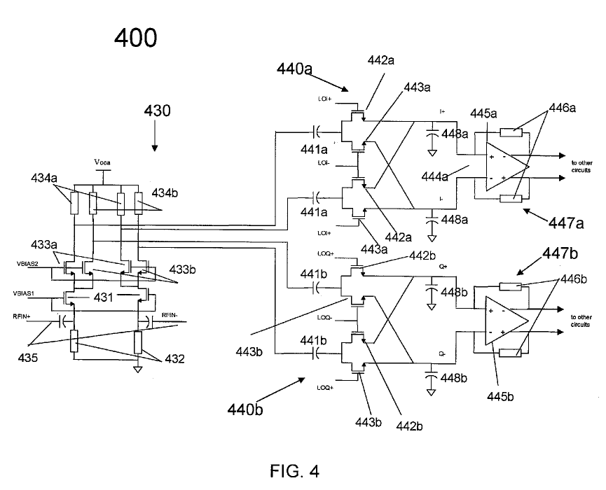

FIG. 4 is a schematic of a circuit 400 that is similar to the circuit 300 shown in FIG. 3 except the circuit 400 uses in-phase and quadrature down-converting passive mixers 440a and 440b to mix differential output signals from a cascoded differential LNA 430 with in-phase and quadrature differential LO signals LOI and LOQ, respectively. The quadrature differential LO signal LOQ has a 90° phase shift from the in-phase LO signal LOI. Furthermore, in-phase and quadrature transimpedance amplifiers 447a and 447b are employed. The differential cascaded LNA 430 can provide for isolation from the mixer side and also increase the gain of the LNA 430. In some implementations, the differential input to the LNA 430 can be converted from a single-ended RF input signal by a balun before the LNA 430. In other implementations, the LNA 430 can be designed to convert a single-ended RF input signal to a differential output signal. In some implementations, the bandwidth of the LNA 330 and the mixer 340 can have a range that covers the full range of frequencies for all bands of a multi-band communication standard or multiple communication standards. For example, in a quad-band GSM systems the bandwidth for the LNA 430 and the mixers 440a and 440b can have a frequency range from 869 MHz to 1990 MHz. In other implementations, the bandwidth for the LNA 430 and the mixers 440a and 440b can have a frequency range to cover all bands in system including a quad-band GSM and WCDMA bands.

FIG. 5 is an example schematic of a circuit 500 that may be used to implement the transimpedance amplifier 347 shown in FIG. 3 and the transimpedance amplifiers 447a and 447b shown in FIG. 4. The circuit 500 uses an operational amplifier including bipolar transistors 510 as input devices of an input stage 501.

The differential input signal 515 can enter the input terminals 511 and 512 of the operational amplifier 500 coupled to the base terminals of bipolar transistors 510. In some implementation, the bipolar transistors are formed by standard complementary-metal-oxide-semiconductor (CMOS) fabrication process technology, or often-called “parasitic” bipolar transistor. In other implementations, the bipolar transistors are formed by bipolar-CMOS (BiCMOS) or by Silicon-Germanium (SiGe) fabrication process technologies.

The current source 570 provides the bias current for the input stage 501 for setting the direct current (DC) operation point for transistors 510. The differential current output signal of the input stage 501 is converted to a differential voltage output signal by load resistors 530. The voltage signal then couples to the gate terminals of MOS transistors 550 and 560 of the output stage 502 of the amplifier 500. Using bipolar transistors 510 instead of MOS transistors at the input stage 501 of the transimpedance amplifier 500 can further improve the noise figure of the mixer 340 shown in FIG. 3 or the mixers 440a and 440b shown in FIG. 4 by, for example, approximately 5 dB without degrading other performance aspects of the transimpedance amplifier 500 (e.g. the gain performance). In other implementations, the transistors 510 can use MOS transistors when it is not necessary to further improve the mixer noise figure.

The output stage 502 of the amplifier 500 uses MOS transistors 550. In some implementations, the output stage 502 of the operational amplifier 500 can be configured as source-follower or voltage-follower which transforms impedances. The current source 580 and 590 provide bias currents for transistors 550 of the output stage 502. The differential output voltage signal Vout 560 of the amplifier 500 can be provided on the source terminals of the MOS transistors 550. The feedback impedances 546a and 546b can amplify and can amplify and convert the differential input signals 515 to a voltage mode. Furthermore, the feedback impedances 546a and 546b can provide a filtering function to attenuate blocker signals.

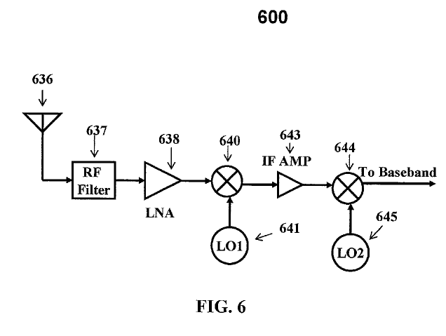

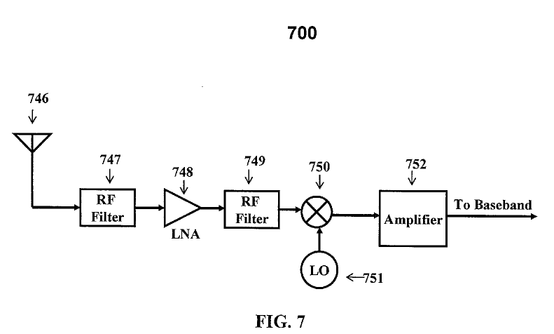

The disclosed techniques can be used with wireless communication systems. For example, the disclosed techniques can be used with receivers and transceivers, such as the receiver and/or transceiver architectures for superheterodyne receivers, image-rejection (e.g., Hartley, Weaver) receivers, zero-intermediate frequency (IF) receivers, low-IF receivers, direct-up transceivers, two-step up transceivers, and other types of receivers and transceivers for wireless and wireline technologies. FIGS. 6 and 7 are schematics demonstrating two examples of such systems.

In particular, FIG. 6 is a schematic of a low IF receiver 600. The receiver 600 may be used as a multi-band GSM receiver.

An RF signal arriving at an antenna 636 passes through a RF filter 637, an LNA 638, and into the first mixer 640, which performs image rejection and translates the RF signal down to an intermediate frequency by mixing it with the signal produced by the first LO 641. In various implementations, the RF filter 637 can be obviated as described above. For example, the RF filter 637 can be avoided by including a common-gate amplifier as the LNA 638 and a down-converting passive mixer as the first mixer 640.

The filtered IF signal is then amplified by a transimpedance amplifier as the IF amplifier stage 643, with the undesired blocker in the IF signal rejected by the feedback impedances of the transimpedance amplifier. The output enters the second mixer 644 that translates it down to yet another intermediate or zero frequency by mixing it with the signal produced by a second LO 645. The signal is then sent to the baseband for processing. The second down-converted signal is sent to a third amplifier before entering an analog-to-digital an analog-to-digital converter (ADC) to convert the signal to a digital signal (not shown) for further digital processing. Additional IF filters and/or amplifiers may be used on the second down-converted signal before being processed by the ADC. For example, a low pass filter may receive the output of the second mixer. Tuning into a particular channel within the band-limited RF signal is accomplished by varying the frequency of each LO 641 and 645. In various implementations, the RF filter 637 can be eliminated and a single LNA 638 can be used to amplify multi-band, for example, quad-band, GSM signals as described above. In some implementations, the first and second mixers, the amplifier, and the low pass filter can be pairs of I and Q mixers I and Q amplifiers, and I and Q low pass filters, similar to the first I and Q mixers shown in FIG. 1.

In another example, FIG. 7 is a schematic of a direct-conversion receiver 700. An antenna 746 couples an RF signal through a first bandpass RF filter 747 into an LNA 748. The signal then proceeds through a second RF filter 749, yielding a band-limited RF signal, which then enters a mixer 750, which mixes the signal with an LO frequency produced by an LO 751. In various implementations, the first and/or second filters 747 and 749 can be eliminated and a single LNA 748 can be used to amplify multi-band, for example, quad-band, GSM signals as described above. For example, the first and/or second filters 747 and 749 can be eliminated and a single LNA 748 can be used for multi-band signals by including a common-gate amplifier as the LNA 748 and a down-converting passive mixer as the mixer 750 followed by a transimpedance amplifier 752. The output of the transimpedance amplifier 752 then proceeds into a baseband for use by the remainder of the communications system.

In some implementations, the positions of circuit components can be exchanged from the disclosed figures with minimal change in circuit functionality. Various topologies for circuit models can also be used. The exemplary designs may use various process technologies, such as CMOS or BiCMOS (Bipolar-CMOS) process technology, or Silicon Germanium (SiGe) technology. In some implementations, switches can be implemented as transmission gate switches. The circuits can be single-ended or fully-differential circuits. Some other communication standards may be compatible with one or more of the implementations, such as General Packet Radio Service (GPRS), Enhanced Data Rates for GSM Evolution (EDGE), Wideband Code Division Multiple Access (WCDMA), High-Speed Downlink Packet Access (HSDPA), and/or GSM-type standards.

The system can include other components. Some of the components may include computers, processors, clocks, radios, signal generators, counters, test and measurement equipment, function generators, oscilloscopes, phase-locked loops, frequency synthesizers, phones, wireless communication devices, and components for the production and transmission of audio, video, and other data. The number and order of variable gain and filter stages can vary. In addition the number of controllable steps, as well as the steps sizes of each of the stages of gain can also vary.

What is claimed is:

1. A circuit for a multi-band Global System for Mobile Communication (GSM) radio frequency (RF) front end comprising:
a single common-gate low noise amplifier (LNA) configured to receive an RF input signal and produce an amplified RF signal;
a down-converting passive mixer configured to mix the amplified RF signal with a local oscillator signal generated by a local oscillator to generate a down-converted signal; and
an amplifier configured to amplify the down-converted signal, wherein the amplifier has an input impedance on the order of ohms.

2. The circuit of claim 1 wherein the down-converting passive mixer is configured to down-convert the amplified RF signal to an intermediate frequency (IF), a low IF or a zero frequency signal.

3. The circuit of claim 1 wherein the down-converting passive mixer is coupled to an output of the single LNA via one or more capacitors to block direct current in the amplified RF signal.

4. The circuit of claim 1 wherein one or more capacitors are coupled between an output of the down-converting passive mixer and a ground for blocking leaked RF signals produced by the local oscillator.

5. The circuit of claim 1 wherein the received RF input signal is differential.

6. The circuit of claim 5 wherein the common-gate LNA, the local oscillator signal, the down-converting passive mixer and the amplifier are differential.

7. The circuit of claim 1 wherein the received RF signal is single-ended.

8. The circuit of claim 7 wherein the common-gate LNA is configured to convert the amplified received signal to a differential signal.

9. The circuit of claim 8 wherein the local oscillator signal, the down-converting passive mixer and the amplifier are differential.

10. The circuit of claim 1 wherein the down-converting passive mixer further comprises transmission gates formed from one or more transistors.

11. The circuit of claim 1 wherein a 3^{rd} order input referred interception point (IIP3) of the LNA is approximately greater than 10 dBm.

12. The circuit of claim 1 wherein the amplifier is a transimpedance amplifier with feedback impedances to amplify and to convert the down-converted signal to a voltage mode.

13. The circuit of claim 12 wherein the transimpedance amplifier comprises an operational amplifier.

14. The circuit of claim 13 wherein the operational amplifier includes one or more bipolar transistors as input devices.

15. The circuit of claim 14 wherein the bipolar transistors reduce a noise figure by approximately 5 dB.

16. The circuit of claim 14 wherein the one or more bipolar transistors are parasitic transistors formed by a complementary metal-oxide-semiconductor (CMOS) or metal-oxide-semiconductor-field-effect-transistor (MOSFET) fabrication process technology.

17. The circuit of claim 1 wherein the RF front end is implemented using a MOSFET, a bipolar-complementary-CMOS (BiCMOS) or a Silicon-Germanium (SiGe) fabrication process technology.

18. The circuit of claim 1 wherein the LNA and the mixer are configured such that a bandwidth of the LNA and the mixer covers a full range of frequencies for all bands of a multi-band communication standard or multiple communication standards.

19. A circuit for a multi-band Global System for Mobile Communication (GSM) radio frequency (RF) receiver comprising:
an antenna configured to receive a radio frequency (RF) input signal;
a switch configured to switch between a transmit mode and a receive mode, wherein when in the receive mode, the switch is configured to pass the received RF input signal through an RF front end that includes a first amplifier configured as a common-gate low noise amplifier, a first mixer configured as a down-converting passive mixer to mix an output signal of the first amplifier with a first local oscillator signal to down-convert the output signal of the first amplifier and a second amplifier configured as a transimpedance amplifier using one or more bipolar transistors as input devices;
a second mixer configured to mix an output of the second amplifier with a second local oscillator signal to down-convert the output of the second amplifier; and
a third amplifier configured to amplify an output of the second mixer.

20. The circuit of claim 19 further comprising an analog to digital converter (ADC) coupled to an output of the third amplifier and configured to convert an output of the third amplifier to a digital output signal before proceeding to a digital signal processor or to a baseband circuit for further processing.

21. The circuit of claim 19 further comprising a transmitter, wherein the receiver and the transmitter are formed on a monolithic transceiver integrated circuit.

22. The circuit of claim 19 wherein the multi-band GSM receiver is formed using a MOSFET, a bipolar-CMOS (BiCMOS) or a Silicon-Germanium (SiGe) fabrication process technology.

23. A method of operating a multi-band Global System for Mobile Communication (GSM) radio frequency (RF) front end comprising:
amplifying an RF input signal with a single common-gate low noise amplifier (LNA) to generate an amplified RF signal;
receiving the amplified RF signal with a down-converting passive mixer and mixing the amplified RF signal with a local oscillator signal generated by a local oscillator to generate a down-converted signal; and
amplifying the down-converted signal with an amplifier, wherein the amplifier has an input impedance on the order of ohms.

24. The method of claim 23 wherein mixing the amplified received RF input signal with a local oscillator signal includes down-converting the amplified RF signal to an IF, a low IF or a zero frequency signal.

25. The method of claim 23 wherein receiving the amplified RF signal with a down-converting passive mixer includes receiving the amplified RF signal via one or more capacitors that block direct current in the amplified RF signal.

26. The method of claim 23 further comprising blocking leaked RF signals the local oscillator using one or more capacitors coupled between an output of the down-converting passive mixer and a ground.

27. The method of claim 23 wherein the RF input signal is differential.

28. The method of claim 27 wherein the common-gate LNA, the local oscillator signal, the down-converting passive mixer and the amplifier are differential.

29. The method of claim 23 wherein the RF input signal is single-ended.

30. The method of claim 29 further comprising converting the RF input signal to a differential signal using the common-gate LNA.

31. The method of claim 30 wherein the local oscillator signal, the down-converting passive mixer and the amplifier are differential.

32. The method of claim 23 wherein the down-converting passive mixer further comprises transmission gates formed from one or more transistors.

33. The method of claim 23 wherein a 3^{rd} order input referred interception point (IIP3) of the LNA is approximately greater than 10 dBm.

34. The method of claim 23 wherein the amplifier is a transimpedance amplifier with feedback impedances to amplify and to convert the down-converted signal to a voltage mode.

35. The method of claim 34 wherein the transimpedance amplifier comprises an operational amplifier.

36. The method of claim 35 where the operational amplifier includes one or more bipolar transistors as input devices.

37. The method of claim 36 wherein the bipolar transistors reduce a noise figure by approximately 5 dB.

38. The method of claim 36 wherein the one or more bipolar transistors are parasitic transistors formed by a complementary metal-oxide-semiconductor (CMOS) or metal-oxide-semiconductor-field-effect-transistor (MOSFET) fabrication process technology.

39. The method of claim 23 wherein the RF front end is implemented using a MOSFET, a bipolar-CMOS (BiCMOS) or a Silicon-Germanium (SiGe) fabrication process technology.

40. The method of claim 23 wherein the LNA and the mixer are configured such that a bandwidth of the LNA and the mixer covers a full range of frequencies for all bands of a multi-band communication standard or multiple communication standards.

41. A multi-band Global System for Mobile Communication (GSM) receiver comprising:
an antenna configured to receive a radio frequency (RF) input signal;
a first amplifier configured as a single common-gate low noise amplifier, wherein the first amplifier is coupled to an output of the antenna;
first down-converting I and Q mixers configured as a passive mixer, wherein the first I and Q down-converting mixers are coupled to an output of the first amplifier and first I and Q local oscillator signals, respectively;
first I and Q amplifiers configured to have an input impedance on the order of ohms, wherein the first I and Q amplifiers are coupled to outputs of the first I and Q down-converting mixers, respectively;
second I and Q mixers coupled to outputs of the I and Q amplifiers and second I and Q local oscillator signals, respectively; and
I and Q low pass filters coupled to I and Q outputs of the second I and Q mixers, respectively.

42. The receiver of claim 41 wherein the first I and Q amplifiers are transimpedance amplifiers.

43. The receiver of claim 41 wherein the LNA has a single-ended input and differential outputs, and the first and the second I and Q mixers, and the first and second I and Q amplifiers are differential.
